(19) United States
(12) Patent Application Publication
(10) Pub. No.: US 2026/0044304 A1
(43) Pub. Date: Feb. 12, 2026

(54) METHOD OF ADJUSTING VOLUME, ELECTRONIC DEVICE, AND NON-TRANSITORY COMPUTER-READABLE STORAGE MEDIUM

(71) Applicant: Beijing Zitiao Network Technology Co., Ltd., Beijing (CN)

(72) Inventors: Ye MA, Beijing (CN); Chang XIAO, Beijing (CN); Jiamin ZHANG, Beijing (CN)

(21) Appl. No.: 19/277,190

(22) Filed: Jul. 22, 2025

(30) Foreign Application Priority Data
Aug. 8, 2024 (CN) 202411087812.4

(51) Int. Cl. G06F 3/16

(52) U.S. Cl. CPC G06F 3/165

(57) ABSTRACT

The present disclosure discloses a method of adjusting volume, an electronic device, and a non-transitory computer-readable storage medium. The method of adjustment volume includes: acquiring media data to be played; determining a volume adjustment type corresponding to the media data to be played; determining a volume adjustment value based on current playback attribute information of a playback terminal that plays media data and the volume adjustment type, in which the volume adjustment value is configured to adjust an initial volume of the media data to be played; adjusting the initial volume according to the volume adjustment value; and playing the media data to be played based on an adjusted initial volume.

### CROSS-REFERENCE TO RELATED APPLICATION

This application claims the priority to and benefits of the Chinese Patent Application, No. 202411087812.4, which was filed on Aug. 8, 2024. The aforementioned patent application is hereby incorporated by reference in its entirety.

### TECHNICAL FIELD

The present disclosure relates to a method of adjusting volume, an electronic device, and a non-transitory computer-readable storage medium.

### BACKGROUND

In related technologies, in response to media data being played on a terminal, the media data is equalized, so as to ensure balanced playback loudness when it is played at the terminal side. However, in the actual playback process, the loudness of certain media data still needs to be manually adjusted by the user after equalization, which affects the user's experience.

### SUMMARY

In view of this, the present disclosure provides a method of adjusting volume, an apparatus, an electronic device, a medium, and a program product, so as to solve the problem of adjusting volume for the media data.

In a first aspect, the present disclosure provides a method for adjusting volume, including:
obtaining media data to be played;
determining a volume adjustment type corresponding to the media data to be played;
determining a volume adjustment value based on current playback attribute information of a playback terminal that plays the media data and the volume adjustment type, in which the volume adjustment value is configured to adjust an initial volume of the media data to be played; and
adjusting the initial volume according to the volume adjustment value, and playing the media data to be played based on an adjusted initial volume.

In a second aspect, the present disclosure provides an electronic device, which includes a memory and a processor, the memory and the processor are communicatively connected with each other, the memory stores a computer instruction, and the processor executes the computer instruction to implement the method of adjusting volume in the first aspect or any of the implementations thereof.

In a third aspect, the present disclosure provides a non-transitory computer-readable storage medium, a computer instruction is stored on the computer-readable storage medium, the computer instruction is configured to enable a computer to implement the method of adjusting volume in the first aspect or any of the implementations thereof.

### BRIEF DESCRIPTION OF DRAWINGS

In order to explain the specific implementation of the present disclosure or the technical scheme in the prior art more clearly, the drawings needed in the description of the specific implementation or the prior art will be briefly introduced below. Obviously, the drawings in the following description are some implementations of the present disclosure, and other drawings can be obtained according to these drawings without creative work for ordinary technicians in the field.

FIG. 1 is a flowchart of a method of adjusting volume provided in an embodiment of the present disclosure;

FIG. 2 is a flowchart of another method of adjusting volume provided in an embodiment of the present disclosure;

FIG. 3 is a flowchart of a method of training a classification model provided in an embodiment of the present disclosure;

FIG. 4 is a flowchart of a method of adjusting volume provided in an embodiment of the present disclosure;

FIG. 5 is a flowchart of a method of training a preset volume adjustment module provided in an embodiment of the present disclosure;

FIG. 6 is a schematic diagram of a sample relationship provided in an embodiment of the present disclosure;

FIG. 7 is a flowchart of yet another method of adjusting volume provided in an embodiment of the present disclosure;

FIG. 8 is a structural block diagram of an apparatus of adjusting volume provided in an embodiment of the present disclosure; and

FIG. 9 is a hardware structural schematic diagram of an electronic device provided in an embodiment of the present disclosure.

### DETAILED DESCRIPTION

In order to make the purpose, technical scheme and advantage of the embodiment of the disclosure clearer, the technical scheme in the embodiment of the present disclosure will be described clearly and completely with the accompanying drawings. Obviously, the described embodiments are some embodiments of the disclosure, but not the all embodiments. Based on the embodiments in the present disclosure, all other embodiments obtained by those skilled in the art without creative work belong to the protection scope of the present disclosure.

In related technologies, in response to media data being played on a terminal, the media data is equalized, so as to ensure balanced playback loudness when it is played at the terminal side. However, in the actual playback process, after certain media data is equalized, the playback volume still cannot satisfy the requirements of a user, which requires the user to manually increase or reduce the volume, which affects the user's experience.

In view of this, the embodiment of the present disclosure provides a method of adjusting volume, which can pertinently adjust an initial volume of media data to be played based on a volume adjustment type corresponding to the media data to be played, so as to achieve a purpose of improving the playback effect of the media data.

According to the embodiments of the present disclosure, an embodiment of a method of adjusting volume is provided. It should be noted that steps shown in the flowchart may be executed in, for example, a computer system including a set of computer executable instructions, and although a logical sequence is shown in the flowchart, in some cases, the steps shown or described may be executed in a different sequence than the one herein.

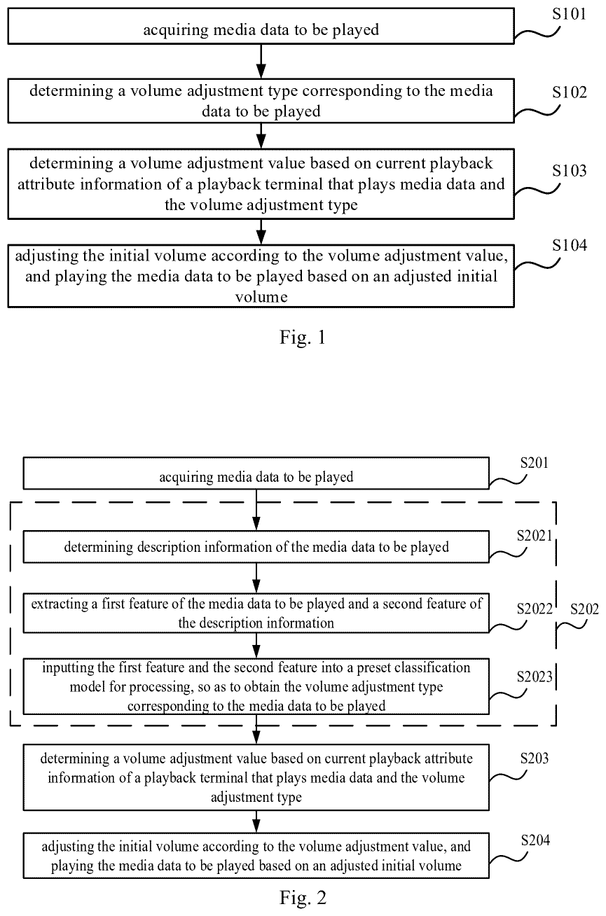

The present embodiment provides a method of adjusting volume that can be used for the foregoing playback terminal, such as a mobile phone, a tablet, and the like. FIG. 1 is a flowchart of a method of adjusting volume according to an embodiment of the present disclosure. As shown in FIG. 1, the process includes the following steps:

Step S101: acquiring media data to be played.

The media data to be played may be understood as any media data that needs to be played. For example, the media data to be played may be an audio or a video that needs to be played. The media data to be played may be newly released media data, or media data with a historical playback record, and may be acquired according to actual requirements.

Step S102: determining a volume adjustment type corresponding to the media data to be played.

In order to reduce a case of invalid adjustment, the volume adjustment type corresponding to the media data to be played is determined in advance, thereby improving the reliability of volume adjustment in the subsequent volume adjustment. For example, the volume adjustment type may include: no volume adjustment, volume increase, volume decrease, or other adjustments. The other adjustment may be understood as that the volume can be increased or decreased.

In some optional examples, the volume adjustment type may be a default volume adjustment type. In other optional examples, the volume adjustment type may be obtained by recognizing a feature of the media data to be played.

Step S103: determining a volume adjustment value based on current playback attribute information of a playback terminal that plays media data and the volume adjustment type.

The playback terminal is a terminal that needs to play the media data to be played. A playback attribute that a terminal device can currently provide can be determined through the current playback attribute information of the playback terminal that plays the media data, and then in response to the volume adjustment value being determined in combination with the volume adjustment type, the volume can be dynamically adjusted according to actual playback situation and environmental factors, so as to satisfy the requirements of playback in different scenarios.

The volume adjustment value is configured to adjust an initial volume of the media data to be played. The volume adjustment value may be understood as a volume difference that the initial volume needs to be increased or decreased. For example, in response to that the volume adjustment value is a positive value, it means that the initial volume needs to be increased by the corresponding volume; and in response to that the volume adjustment value is a negative value, it means that the initial volume needs to be reduced.

The current playback attribute information may include, but is not limited to, any of the following sub-information: a current playback volume of a system corresponding to the playback terminal, an average playback volume within a specified historical duration, current playback environment information, and current playback time information. The specified duration may be a specified time interval from when the media data to be played is currently played. For example, the specified duration may be the last 7 days, 15 days, or 30 days to ensure the reliability of the subsequent determination of the volume adjustment value. The time span unit and time length of the specified time interval may be determined based on actual requirements.

Step S104: adjusting the initial volume according to the volume adjustment value, and playing the media data to be played based on an adjusted initial volume.

The volume adjustment value is applied to the initial volume of the media data to be played, the volume is adjusted to obtain the adjusted initial volume, and the media data to be played is played with the adjusted initial volume, such that the playback loudness may satisfy an expectation, thereby reducing the probability that the volume of the media data to be played is adjusted during playback, so that the obtained volume to be played is more in line with an playback expectation.

The volume adjustment method provided in the present embodiment determines the volume adjustment value based on the volume adjustment type corresponding to the media data to be played and the current attribute information of the playback terminal, and is capable of dynamically adjusting the initial volume according to the actual playback situation and the environmental factor, thereby satisfying the playback demand in the current scenario and improving the playback effect of the media data.

The present embodiment provides a method of adjusting volume that can be used for the foregoing playback terminal, such as a mobile phone, a tablet, and the like. FIG. 2 is a flowchart of a method of adjusting volume according to an embodiment of the present disclosure. As shown in FIG. 2, the process includes the following steps:

Step S201: acquiring media data to be played. For details, please refer to step S101 of the embodiment shown in FIG. 1, which is not described again here.

Step S202: determining a volume adjustment type corresponding to the media data to be played.

For example, the step S202 above includes:

Step S2021: determining description information of the media data to be played.

The description information of the media data to be played is text information that is configured to describe or express content of the media data to be played. By determining the description information of the media data to be played, it is helpful to provide more references for subsequent feature extraction and classification, and then it is helpful to improve the accuracy in judging the volume adjustment type.

In some optional examples, the description information includes: at least one selected from a group of data description information for the media data to be played, comment information for the media data to be played, and combination thereof. The data description information may be a title, an introduction, a tag, a classification, and other information of the media data to be played. The comment information may be the information that comments on the playback situation in a historical playback process of the media data to be played. In response to that there are a large number of actual comments on the media data to be played, a specified number of actual comments with the highest degree of interaction may be acquired as the comment information, which can improve the efficiency in subsequent feature analysis.

In some optional application scenarios, a relevant document, a tag, or metadata of the media data to be played may be analyzed and processed, so as to obtain the description information of the media data to be played.

Step S2022: extracting a first feature of the media data to be played and a second feature of the description information.

The first feature extraction on the media data to be played may extract a first feature that may reflect the characteristics thereof, such as a frequency and an amplitude of an audio, a frame rate of a video, and an image complexity of a video. In some optional scenarios, the first feature extraction process depends on a data type of the media data to be played. For example, in response to that the media data to be played is audio data, an audio signal processing technology may be used to extract a feature such as a frequency, an amplitude, and a duration as the first feature. In response to that the media data to be played is video data, an image processing technology may be used to extract a feature such as a frame rate, an image brightness, a contrast, and a color as the first feature.

The second feature extraction on the description information may extract a second feature that may reflect the characteristics of the content thereof, such as a keyword and a semantic feature in the description information. In some optional implementations, a natural language processing technology may be used for lexical analysis, syntactic analysis, and semantic understanding, and then a keyword, a semantic feature, or the like may be extracted from the description information as the second feature. For example, a bag-of-words model, a TF-IDF algorithm, or the like, may be used to extract an important word or phrase in the description information, or a deep-learning model such as a recurrent neural network (RNN), a long short-term memory network (LSTM), or the like, may be used to extract the second feature.

Preferably, a multimodal model may be used to perform feature processing on the media data to be played and the description information respectively, such that the first feature and the second feature obtained may be in a same dimension, which simplifies the processing complexity of the data, reduces the time consumption, and improves the classification efficiency in the subsequent classification processing. For example, the multimodal model may be a contrastive language-audio pretraining (CLAP) model, or a deep learning-based speech representation learning model (for example, the name is wav2vec).

By extracting the first feature and the second feature, the complex media data to be played and the description information may be transformed into a quantifiable and comparable form, so as to provide effective input data for the subsequent classification model and improve the accuracy and generalization ability of the model.

Step S2023: inputting the first feature and the second feature into a preset classification model for processing, so as to obtain the volume adjustment type corresponding to the media data to be played.

The classification model is a pre-trained model that is configured to classify the volume adjustment of the media data. In the classification model, the first feature and the second feature that are input may be analyzed and determined independently to further obtain the volume adjustment type corresponding to the media data to be played, which can effectively avoid the subjectivity and uncertainty of manual judgment, thereby helping to improve the reliability and objectivity of the volume adjustment type and the determination efficiency of volume adjustment type.

In some optional implementation scenarios, the classification model may be deployed in the cloud, and then based on the interaction between the playback device and the cloud, the volume adjustment type may be determined through the cloud, which can effectively save the storage space and computing resources of the playback device, at the same time, the powerful computing power of the cloud may be used to quickly obtain the result of the volume adjustment type. In addition, by deploying the classification model in the cloud in advance, it is easier for the cloud to update and optimize the classification model, thereby ensuring the judgment accuracy and adaptability of the volume adjustment type. Furthermore, because the classification model is deployed in the cloud, a plurality of playback devices may share a same model service through interaction with the cloud, such that the problem of inconsistent determination standards due to terminal differences may be avoided in response to determining the volume adjustment type.

In other optional implementation scenarios, the classification model may be deployed in a local memory of the playback device, which can reduce the dependence on the network and improve the response efficiency.

Step S203: determining a volume adjustment value based on current playback attribute information of a playback terminal that plays media data and the volume adjustment type. For details, please refer to step S103 of the embodiment shown in FIG. 1, which is not described again here.

Step S204: adjusting the initial volume according to the volume adjustment value, and playing the media data to be played based on an adjusted initial volume. For details, please refer to step S103 of the embodiment shown in FIG. 1, which is not described again here.

The volume adjustment method provided in the present embodiment, by determining the description information of the media data to be played, extracting the first feature thereof and the second feature of the description information, and inputting the features into a preset classification model for processing, the automatic judgment and determination of the volume adjustment type of the media data to be played can be realized, and then the volume adjustment is carried out on this basis, thereby improving the adjustment efficiency and reliability, and providing the user with better playback experience.

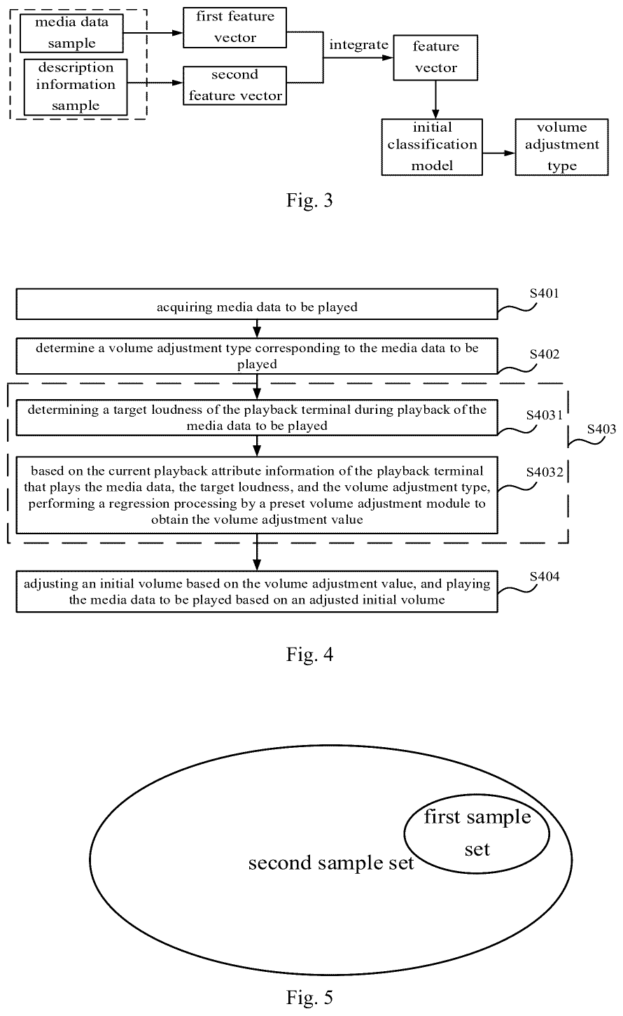

In some optional implementation scenarios, the classification model is pre-trained on a large number of feature sample pairs. A feature sample pair includes a data feature sample of a media data sample and an information sample feature corresponding to the description information sample of the media data sample. The training process of the classification model may be shown in FIG. 3, which includes: combining a first feature vector corresponding to the data feature sample in the current feature sample pair and a second feature vector of the information sample feature corresponding to the description information sample into a feature vector corresponding to the current feature sample, and inputting the feature vector into the initial classification model for classification training, then the relationship between different feature vectors and volume adjustment types can be learned, so as to obtain a final classification model.

In some other optional implementation scenarios, the output of the classification model is any integer value from 0 to 3 to represent different volume adjustment types, such that the system of the playback terminal may quickly determine the corresponding volume adjustment type according to the output result of the classification model, thereby simplifying the determination process, making the subsequent processing process more concise and efficient, and being beneficial to improving performance.

In some examples, the corresponding relationship between the numerical value and the volume adjustment type may be shown in Table 1:

TABLE 1

| Output value | Volume adjustment type |
|---|---|
| 0 | No volume adjustment |
| 1 | Volume increase |
| 2 | Volume decrease |
| 3 | Others |

It should be noted that the corresponding relationship shown in Table 1 above is only an example, and the specific corresponding relationship may be set according to requirements, which is not described again here.

The present embodiment provides a method of adjusting volume that can be used for the foregoing playback terminal, such as a mobile phone, a tablet, and the like. FIG. 4 is a flowchart of a method of adjusting volume according to an embodiment of the present disclosure. As shown in FIG. 4, the process includes the following steps:

Step S401: acquiring media data to be played.

Step S402: determine a volume adjustment type corresponding to the media data to be played.

Step S403: determining a volume adjustment value based on current playback attribute information of a playback terminal that plays media data and the volume adjustment type.

For example, the foregoing step S403 includes:

Step S4031: determining a target loudness of the playback terminal during playback of the media data to be played.

The target loudness refers to a desired loudness level of the sound. For example, in a quiet environment, a user may want a lower volume, while in a noisy environment, the user may need a higher volume to hear the content clearly.

Because the user has a certain loudness requirement for the playback of the media data in response to using the playback terminal to play the media data, in order to improve the reliability of volume adjustment, the target loudness of the media data to be played of the playback terminal during playback of the media data to be played is determined, such that the subsequent process of determining the volume adjustment value is more targeted, and in response to the media data to be played after volume adjustment being played, the loudness corresponding to the adjusted initial volume may be more in line with the target loudness. The target loudness may be determined based on a setting of the user or the current setting of the system.

Step S4032: based on the current playback attribute information of the playback terminal that plays the media data, the target loudness, and the volume adjustment type, performing a regression processing by a preset volume adjustment module to obtain the volume adjustment value.

The current playback attribute information of the playback terminal that plays the media data is collected, and the current playback attribute information, the target loudness, and the volume adjustment type are taken as inputs, which are input into the preset volume adjustment module for analysis and regression processing, so as to carry out comprehensive analysis from a multi-dimensional perspective to make the determined volume adjustment value more reliable and effective, thereby saving time and effort of the user to manually adjust the volume, and improving the efficiency of the volume adjustment, so as to improve the playback quality and auditory effect of the media data to be played.

In some optional implementation scenarios, the preset volume adjustment module is obtained through a mode of offline training, and therefore in-depth analysis and processing may be performed on massive data, reducing the requirements for real-time performance, which can not only improve resource utilization, but also effectively save training costs.

In some other optional implementation scenarios, the preset volume adjustment module may be obtained through a mode of online training, and therefore can be adjusted and optimized in real time according to the latest behavior of the user and environmental changes, so as to ensure the reliability in determining the volume adjustment value.

In some optional implementations, the foregoing step S4032 includes:
Step a1: acquiring a first sample set;
Step a2: determining a volume adjustment average value of the first sample set according to playback attribute reference information of the playback terminal; and
Step a3: training an initial volume adjustment model based on the playback attribute reference information, the volume adjustment average value, and the volume adjustment type, so as to obtain the preset volume adjustment module.

A volume adjustment type corresponding to each target media data sample in the first sample set indicates a requirement for volume adjustment.

For example, in order to improve the training quality, a plurality of target media data samples that require volume adjustment are acquired in advance as the first sample set for training the initial volume adjustment model, and in the subsequent training process, the initial volume adjustment model can learn how to process the cases that require volume adjustment. Based on the playback attribute reference information of the playback terminal, the volume adjustment average value of the first sample set is determined, so as to determine the degree of volume adjustment that is generally required for playing the media data according to the playback attribute reference information, which provides an important reference for model training.

The playback attribute reference information, the volume adjustment average value, and the volume adjustment type are taken as inputs, which are input into the initial volume adjustment model for model training, so as to learn how to use the above input information to predict an appropriate volume adjustment value, thereby obtaining the required preset volume adjustment module. In some examples, it can be trained by a neural network or by a specified regression algorithm. For example, the specified regression algorithm may be any of the following: linear regression, polynomial regression, decision tree, or support vector machine classifier, and the specified regression algorithm may be determined as required. Preferably, the initial volume adjustment model may be trained by the specified regression algorithm, which helps to improve the training efficiency and obtain the preset volume adjustment module quickly.

To sum up, obtaining the preset volume adjustment module by model training in the above mode may effectively improve the intelligence and automation level of volume adjustment.

In some optional examples, the playback attribute reference information may include at least one selected from the group of: a playback volume of the system corresponding to the playback terminal, an average playback volume within a specified historical duration, playback environment information, and playback time information, and combinations thereof, which, in response to determining the volume adjustment value in the subsequent application process, makes the trained preset volume adjustment module more intelligent, personalized, and adaptable, so as to bring users better use experience.

In some optional examples, the foregoing step a1 includes:
Step a11: acquiring a second sample set;
Step a12: determining, by the preset classification model, a volume adjustment type corresponding to each of the plurality of media data samples, and taking a media data sample of a volume adjustment type that requires for volume adjustment as the target media data sample, so as to obtain the first sample set.

The second sample set includes a plurality of media data samples and description information samples corresponding to the plurality of media data samples. In the second sample set, the volume adjustment types corresponding to each media data sample are not exactly the same, and there is a volume adjustment type that requires volume adjustment or a volume adjustment type that does not require volume adjustment. In order to improve the training effectiveness and pertinence of the preset volume adjustment module and reduce invalid training, the foregoing classification model is used to screen the samples to identify the media data samples that require volume adjustment in the plurality of media data samples, and take them as target media data samples to obtain the first sample set for training the initial volume adjustment model, which effectively shortens the training time and improves the training efficiency and accuracy of the initial volume adjustment model, provides a basis for subsequent formulation and implementation of volume adjustment strategies, and helps to improve the listening experience of users and the quality of media content. That is, as shown in FIG. 5, the relationship between the second sample set and the first sample set may be the relationship between inclusion and inclusion.

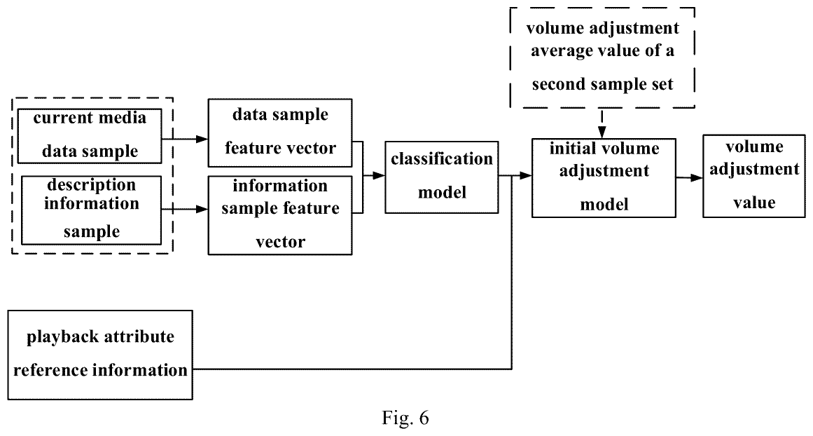

In some optional implementation scenarios, the training process of the preset volume adjustment module may be shown in FIG. 6, which includes: for the current media data sample and the description information sample corresponding to the current media data sample, performing a feature extraction processing on the current media data sample to obtain a data sample feature vector, and performing an feature extraction processing on the description information sample corresponding to the current media data sample to obtain an information sample feature vector. The data sample feature vector and the information sample feature vector are input into the classification model for processing to determine the volume adjustment type corresponding to the current media data sample. In response to the volume adjustment type corresponding to the current media data sample is the media data sample that requires volume adjustment, the current media data sample is taken as the target media data sample, which is input into an initial volume adjustment model for regression processing, together with the playback attribute reference information (at the same time, the playback volume of the system corresponding to the playback terminal, the average playback volume within the specified historical duration, the playback environment information, and the playback time information), a volume adjustment average value of a second sample set, and the volume adjustment type corresponding to the current media data sample, so as to determine the volume adjustment value corresponding to the current media data sample. In response to that corresponding volume adjustment values corresponding to a plurality of target media data samples are obtained, or a loss value of the initial volume adjustment model is lower than a preset threshold, the training is completed and the preset volume adjustment module is obtained.

Step S404: adjusting an initial volume based on the volume adjustment value, and playing the media data to be played based on an adjusted initial volume.

The volume adjustment method provided in the present embodiment determines the volume adjustment value based on the current playback attribute information of the playback terminal that plays the playback media data and the volume adjustment type, which can provide the user with better audio experience, and improve both the efficiency and accuracy of the volume adjustment.

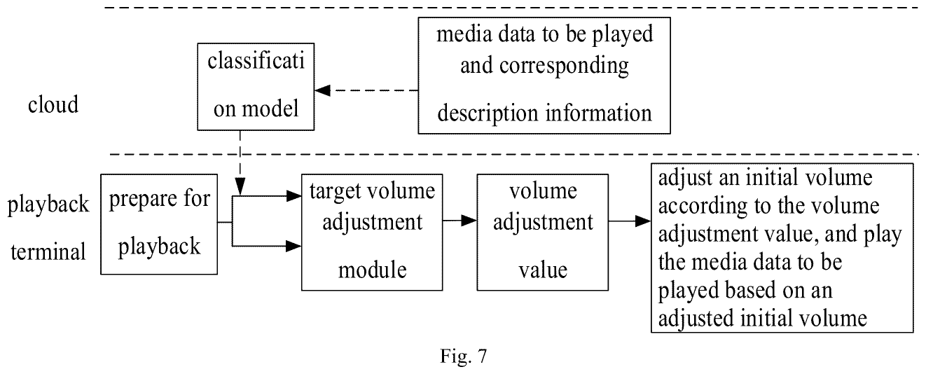

As one or more specific application embodiments of the present disclosure, FIG. 7 shows a process for deploying a classification model in a cloud in advance and then adjusting volume through a playback terminal.

In the cloud, based on media data to be played and corresponding description information, through the classification model, a volume adjustment type corresponding to the media data to be played can be determined, and the volume adjustment type corresponding to the media data to be played is sent to the playback terminal.

In the playback terminal, in response to the current media data to be played is the media data to be played, a regression processing is performed through the preset volume adjustment module according to current playback attribute information of the playback terminal that plays the media data, a target loudness, and the volume adjustment type, so as to obtain a volume adjustment value, then an initial volume according to the volume adjustment value is adjusted, and the media data to be played is played based on the adjusted initial volume.

According to the foregoing volume adjustment method, the process of volume adjustment can be more scientific and targeted, so that the playback volume to be played of the obtained target media data is more in line with expectations, which facilitates improving the playback quality and effect of the media data to be played.

The present embodiment further provides an apparatus of adjusting volume, the apparatus is configured to implement the foregoing embodiments and the preferred embodiments, among which, those that have been described are not described again here. As used herein below, the term “module” may be a combination of software and/or hardware that implements a predetermined function. Although the apparatus described in the following embodiments is preferably embodied in software, it may also be possible and conceivable that the apparatus is embodied in hardware, or a combination of software and hardware.

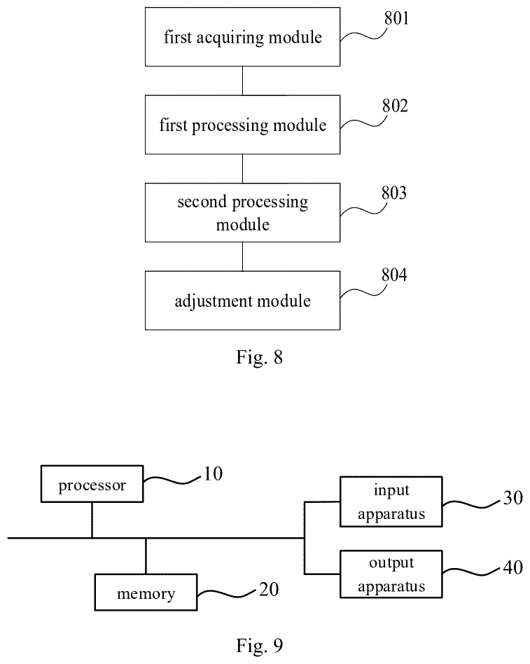

The present embodiment provides an apparatus of adjusting volume, as shown in FIG. 8, including:
a first acquiring module 801, configured to acquire media data to be played;
a first processing module 802, configured to determine a volume adjustment type corresponding to the media data to be played;
a second processing module 803, configured to determine a volume adjustment value based on current playback attribute information of a playback terminal that plays media data and the volume adjustment type, in which the volume adjustment value is configured to adjust an initial volume of the media data to be played;
an adjustment module 804, configured to adjust the initial volume according to the volume adjustment value, and play the media data to be played based on an adjusted initial volume.

In some optional implementations, the first processing module 802 includes:
a first determining unit, configured to determine description information of the media data to be played;
a feature extraction unit, configured to extract a first feature of the media data to be played and a second feature of the description information;
a first processing unit, configured to input the first feature and the second feature into a preset classification model for processing, so as to obtain the volume adjustment type corresponding to the media data to be played.

In some optional implementations, the description information includes: at least one selected from a group of data description information for the media data to be played, comment information for the media data to be played, and combination thereof.

In some optional implementations, the second processing module 803 includes:
a second determining unit, configured to determine a target loudness in response to the playback terminal playing the media data to be played;
a second processing unit, configured to, based on the current playback attribute information of the playback terminal that plays the media data, the target loudness, and the volume adjustment type, perform a regression processing by a preset volume adjustment module to obtain the volume adjustment value.

In some optional implementations, the process for training the preset volume adjustment module includes:
a second acquiring module, configured to acquire a first sample value, in which a volume adjustment type corresponding to each target media data sample in the first sample set indicates a requirement for volume adjustment;
a third processing module, configured to determine a volume adjustment average value of the first sample set according to playback attribute reference information of the playback terminal; and
a training module, configured to train an initial volume adjustment model based on the playback attribute reference information, the volume adjustment average value, and the volume adjustment type, so as to obtain the preset volume adjustment module.

In some optional implementations, the second acquiring module includes:
a sample acquiring unit, configured to acquire a second sample set, in which the second sample set includes a plurality of media data samples and description information samples corresponding to the plurality of media data samples;
a filtering unit, configured to, by the preset classification model, determine a volume adjustment type corresponding to each of the plurality of media data samples, and take a media data sample of a volume adjustment type that requires for volume adjustment as the target media data sample, so as to obtain the first sample set.

In some optional implementations, the playback attribute reference information includes at least one selected from the group of a playback volume of a system corresponding to the playback terminal, an average playback volume within a specified historical duration, playback environment information, and playback time information, and combinations thereof.

In some optional implementations, the preset volume adjustment module is obtained through a mode of offline training.

The further functional descriptions of the foregoing modules and units are the same as the foregoing corresponding embodiments, and are not described again here.

The volume adjustment apparatus in the present embodiment is presented in the form of a functional unit, where the unit refers to an application-specific integrated circuit (ASIC), a processor and memory that execute one or more software or fixed programs, and/or other devices that can provide the foregoing functions.

The embodiments of the present disclosure further provide an electronic device with a volume adjusting apparatus as shown in FIG. 8 above.

Please refer to FIG. 9, FIG. 9 is a schematic structural diagram of an electronic device provided by an alternative embodiment of the present disclosure. As shown in FIG. 9, the electronic device includes one or more processors 10, a memory 20, and interfaces for connecting various components, including a high-speed interface and a low-speed interface. The components are connected with each other by different buses, and can be installed on a common motherboard or in other ways as needed. The processor may process instructions executed in the electronic device, including instructions stored in or on the memory to display graphical information of the GUI on an external input/output device, such as a display device coupled to an interface. In some alternative embodiments, a plurality of processors and/or a plurality of buses may be used with a plurality of memories, if necessary. Similarly, a plurality of electronic devices can be connected, and each device provides some necessary operations (for example, as a server array, a group of blade servers, or a multiprocessor system). In FIG. 9, one processor 10 is taken as an example.

The processor 10 may be a central processor, a network processor or a combination thereof. The processor 10 may further include a hardware chip. The hardware chip can be an application specific integrated circuit, a programmable logic device or a combination thereof. The programmable logic device can be a complex programmable logic device, a field programmable logic gate array, a generic array logic or any combination thereof.

The memory 20 stores instructions that can be executed by at least one processor 10, so that the at least one processor 10 can execute the method shown in the above embodiment.

The memory 20 may include a storage program region and a storage data region, the storage program region may store an operating system and an application program required by at least one function; the storage data region can store data created according to the use of electronic device and the like. In addition, the memory 20 may include a high-speed random access memory, and a non-transitory memory, such as at least one disk memory device, flash memory device, or other non-transitory solid-state memory devices. In some alternative embodiments, the memory 20 may optionally include memories remotely located with respect to the processor 10, and these remote memories may be connected to the electronic device through a network. Examples of the above networks include, but are not limited to, the Internet, an intranet, a local area network, a mobile communication network, and combinations thereof.

The memory 20 may include a volatile memory, for example, a random access memory; the memory can also include a non-volatile memory, such as a flash memory, a hard disk or a solid state hard disk; the memory 20 may also include a combination of the above kinds of memories.

The electronic device further includes an input apparatus 30 and an output apparatus 40. The processor 10, the memory 20, the input apparatus 30 and the output apparatus 40 may be connected by a bus or other means, for example, in FIG. 9, taking that they are connected by a bus as an example.

The input apparatus 30 can receive input digital or character information, and generate key signal input related to user settings and function control of the electronic device, such as a touch screen, a keypad, a mouse, a track pad, a touch pad, a pointing stick, one or more mouse buttons, a trackball, a joystick and the like. The output apparatus 40 may include a display device, an auxiliary lighting apparatus (for example, an LED), a tactile feedback apparatus (for example, a vibration motor), and the like. The above display devices include, but are not limited to, liquid crystal displays, light emitting diodes, displays and plasma displays. In some alternative embodiments, the display device may be a touch screen.

The embodiment of the present disclosure also provides a computer-readable storage medium, and the above-mentioned method according to the embodiment of the present disclosure can be implemented in hardware, firmware, or computer code that can be recorded in a storage medium, or downloaded through a network and originally stored in a remote storage medium or a non-temporary machine-readable storage medium and will be stored in a local storage medium, so that the method described herein can be processed by such software stored on a storage medium using a general-purpose computer, a special-purpose processor or programmable or special-purpose hardware. The storage medium can be a magnetic disk, an optical disk, a read-only memory, a random access memory, a flash memory, a hard disk or a solid-state hard disk, etc. Further, the storage medium may also include a combination of the above kinds of memories. It can be understood that a computer, a processor, a microprocessor controller or a programmable hardware includes a storage component that can store or receive software or computer code, and in response to the software or computer code is accessed and executed by the computer, the processor or the hardware, the method shown in the above embodiment is realized.

A part of the present disclosure can be applied as a computer program product, such as a computer program instruction, which, when executed by a computer, can call or provide the method and/or technical solution according to the present disclosure through the operation of the computer. Those skilled in the art should understand that the existing form of the computer program instruction in computer-readable media, includes but not limited to a source file, an executable file, an installation package file, etc. Accordingly, ways in which the computer program instruction is executed by the computer include but are not limited to: the computer directly executing the instruction, or the computer compiling the instruction before executing the corresponding compiled programs, or the computer reading and executing the instruction, or the computer reading and installing the instruction before executing the corresponding installed programs. Here, the computer-readable medium can be any available computer-readable storage medium or communication medium that can be accessed by a computer.

It can be understood that before using the technical solutions disclosed in various embodiments of this disclosure, users should be informed of the types, scope of use, use scenarios, etc. of personal information involved in this disclosure in an appropriate way according to relevant laws and regulations and be authorized by users.

For example, in response to receiving the user's active request, prompt information is sent to the user to clearly remind the user that the operation requested by the user will require obtaining and using the user's personal information. Therefore, the user can independently choose whether to provide personal information to software or hardware such as electronic devices, applications, servers or storage media that perform the operation of the technical scheme of the present disclosure according to the prompt information.

As an optional but non-limiting implementation, in response to receiving the user's active request, the way to send the prompt information to the user can be, for example, a pop-up window, in which the prompt information can be presented in text. In addition, the pop-up window can also carry a selection control for the user to choose “agree” or “disagree” to provide personal information to the electronic device.

It can be understood that the above process of notifying and obtaining user authorization is only schematic, and does not limit the implementation of this disclosure. Other ways to meet relevant laws and regulations can also be applied to the implementation of this disclosure.

Although the embodiments of the present disclosure have been described in connection with the drawings, those skilled in the art can make various modifications and variations without departing from the spirit and scope of the present disclosure, and such modifications and variations are all within the scope defined by the appended claims.

1. A method of adjusting volume, comprising:
acquiring media data to be played;
determining a volume adjustment type corresponding to the media data to be played;
determining a volume adjustment value based on current playback attribute information of a playback terminal that plays media data and the volume adjustment type, wherein the volume adjustment value is configured to adjust an initial volume of the media data to be played; and
adjusting the initial volume according to the volume adjustment value, and playing the media data to be played based on an adjusted initial volume.

2. The method according to claim 1, wherein the determining a volume adjustment type corresponding to the media data to be played, comprises:
determining description information of the media data to be played;
extracting a first feature of the media data to be played and a second feature of the description information; and
inputting the first feature and the second feature into a preset classification model for processing, so as to obtain the volume adjustment type corresponding to the media data to be played.

3. The method according to claim 2, wherein the description information comprises at least one selected from a group of: data description information for the media data to be played, comment information for the media data to be played, and combination thereof.

4. The method according to claim 1, wherein the determining a volume adjustment value based on current playback attribute information of a playback terminal that plays media data and the volume adjustment type, comprises:
determining a target loudness of the playback terminal during playback of the media data to be played; and
based on the current playback attribute information of the playback terminal that plays the media data, the target loudness, and the volume adjustment type, performing a regression processing by a preset volume adjustment module to obtain the volume adjustment value.

5. The method according to claim 4, wherein a process for training the preset volume adjustment module comprises:
acquiring a first sample set, wherein a volume adjustment type corresponding to each target media data sample in the first sample set indicates a requirement for volume adjustment;
determining a volume adjustment average value of the first sample set according to playback attribute reference information of the playback terminal; and
training an initial volume adjustment model based on the playback attribute reference information, the volume adjustment average value, and the volume adjustment type, so as to obtain the preset volume adjustment module.

6. The method according to claim 5, wherein the acquiring a first sample set, comprises:
acquiring a second sample set, wherein the second sample set comprises a plurality of media data samples and description information samples corresponding to the plurality of media data samples;
determining, by a preset classification model, a volume adjustment type corresponding to each of the plurality of media data samples, and taking a media data sample of a volume adjustment type that requires for volume adjustment as the target media data sample, so as to obtain the first sample set.

7. The method according to claim 5, wherein the playback attribute reference information comprises at least one selected from a group of a playback volume of a system corresponding to the playback terminal, an average playback volume within a specified historical duration, playback environment information, playback time information, and combinations thereof.

8. The method according to claim 4, wherein the preset volume adjustment module is obtained through a mode of offline training.

9. An electronic device, comprising:
a memory and a processor, wherein the memory and the processor are communicatively connected with each other, the memory stores a computer instruction, and the processor executes the computer instruction to implement:
acquiring media data to be played;
determining a volume adjustment type corresponding to the media data to be played;
determining a volume adjustment value based on current playback attribute information of a playback terminal that plays media data and the volume adjustment type, wherein the volume adjustment value is configured to adjust an initial volume of the media data to be played; and
adjusting the initial volume according to the volume adjustment value, and playing the media data to be played based on an adjusted initial volume.

10. The electronic device according to claim 9, wherein the determining a volume adjustment type corresponding to the media data to be played, comprises:
determining description information of the media data to be played;
extracting a first feature of the media data to be played and a second feature of the description information; and
inputting the first feature and the second feature into a preset classification model for processing, so as to obtain the volume adjustment type corresponding to the media data to be played.

11. The electronic device according to claim 10, wherein the description information comprises at least one selected from a group of: data description information for the media data to be played, comment information for the media data to be played, and combination thereof.

12. The electronic device according to claim 9, wherein the determining a volume adjustment value based on the current playback attribute information of a playback terminal that plays the media data and the volume adjustment type, comprises:
determining a target loudness of the playback terminal during playback of the media data to be played; and
based on the current playback attribute information of the playback terminal that plays the media data, the target loudness, and the volume adjustment type, performing a regression processing by a preset volume adjustment module to obtain the volume adjustment value.

13. The electronic device according to claim 12, wherein a process for training the preset volume adjustment module, comprises:
acquiring a first sample set, wherein a volume adjustment type corresponding to each target media data sample in the first sample set indicates a requirement for volume adjustment;
determining a volume adjustment average value of the first sample set according to playback attribute reference information of the playback terminal; and
training an initial volume adjustment model based on the playback attribute reference information, the volume adjustment average value, and the volume adjustment type, so as to obtain the preset volume adjustment module.

14. The electronic device according to claim 13, wherein the acquiring a first sample set, comprises:
acquiring a second sample set, wherein the second sample set comprises a plurality of media data samples and corresponding description information samples corresponding to the plurality of media data samples;
determining, by a preset classification model, a volume adjustment type corresponding to each of the plurality of media data samples, and taking a media data sample of a volume adjustment type that requires for volume adjustment as the target media data sample, so as to obtain the first sample set.

15. The electronic device according to claim 13, wherein the playback attribute reference information comprises at least one selected from a group of:
a playback volume of a system corresponding to the playback terminal, an average playback volume within a specified historical duration, playback environment information, and playback time information, and combinations thereof.

16. The electronic device according to claim 12, wherein the preset volume adjustment module is obtained through a mode of offline training.

17. A non-transitory computer-readable storage medium, wherein a computer instruction is stored on the computer-readable storage medium, the computer instruction is configured to enable a computer to implement:
acquiring media data to be played;
determining a volume adjustment type corresponding to the media data to be played;
determining a volume adjustment value based on current playback attribute information of a playback terminal that plays media data and the volume adjustment type, wherein the volume adjustment value is configured to adjust an initial volume of the media data to be played; and
adjusting the initial volume according to the volume adjustment value, and playing the media data to be played based on an adjusted initial volume.

18. The non-transitory computer-readable storage medium according to claim 17, wherein the determining a volume adjustment type corresponding to the media data to be played, comprises:
determining description information of the media data to be played;
extracting a first feature of the media data to be played and a second feature of the description information; and
inputting the first feature and the second feature into a preset classification model for processing, so as to obtain the volume adjustment type corresponding to the media data to be played.

19. The non-transitory computer-readable storage medium according to claim 18, wherein the description information comprises at least one selected from a group of: data description information for the media data to be played, comment information for the media data to be played, and combination thereof.

20. The non-transitory computer-readable storage medium according to claim 17, wherein the determining a volume adjustment value based on current playback attribute information of a playback terminal that plays media data and the volume adjustment type, comprises:
determining a target loudness of the playback terminal during playback of the media data to be played; and
based on the current playback attribute information of the playback terminal that plays the media data, the target loudness, and the volume adjustment type, performing a regression processing by a preset volume adjustment module to obtain the volume adjustment value.
